(19) United States
(12) Patent Application Publication
(10) Pub. No.: US 2026/0299074 A1
(43) Pub. Date: Oct. 1, 2026

(54) SYSTEM AND METHOD FOR TUNABLE ACOUSTIC DIRECTION SENSING USING A CAPACITIVELY COUPLED CIRCUIT

(71) Applicant: Toyota Motor Engineering & Manufacturing North America, Inc., Plano, TX (US)

(72) Inventors: Taehwa Lee, Ann Arbor, MI (US); Ziqi Yu, Ann Arbor, MI (US); Xiaoshi Su, Ann Arbor, MI (US); Ercan Mehmet Dede, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/564,621

(22) Filed: Mar. 12, 2026

Related U.S. Application Data
(63) Continuation-in-part of application No. 19/042,392, filed on Jan. 31, 2025.
(60) Provisional application No. 63/939,453, filed on Dec. 12, 2025.

(51) Int. Cl. G01S 3/801; G01S 3/803

(52) U.S. Cl. CPC G01S 3/801; G01S 3/8034

(57) ABSTRACT

Systems and methods for tunable acoustic direction sensing are described herein. In one example, a system includes a first circuit and a second circuit capacitively coupled by a coupling capacitor, wherein the first circuit and the second circuit each comprise an inductor, a capacitor, and a resistor forming a frequency-selective network. A first acoustic transducer is coupled to the first circuit and a second acoustic transducer is coupled to the second circuit. At least one electrical element of the first circuit, the second circuit, or the coupling capacitor is a tunable electrical element configured to alter at least one of a resonance frequency, a bandwidth, or a damping characteristic of the first circuit or the second circuit. The first circuit and the second circuit generate respective output voltages that differ as a function of an incident angle of an acoustic wave, enabling determination of a direction of the acoustic wave.

### CROSS-REFERENCE TO RELATED APPLICATIONS

This application is a continuation-in-part of U.S. Non-Provisional patent application Ser. No. 19/042,392, filed Jan. 31, 2025, entitled “SYSTEM FOR DETERMINING THE DIRECTION OF AN ACOUSTIC WAVE USING A CAPACITIVELY COUPLED CIRCUIT”, and claims the benefit of U.S. Provisional Patent Application No. 63/939,453, filed Dec. 12, 2025, entitled “SYSTEM AND METHOD FOR TUNABLE ACOUSTIC DIRECTION SENSING”, the entire disclosures of which are incorporated herein by reference in their entireties.

### TECHNICAL FIELD

The subject matter described herein relates, in general, to systems and methods for determining a direction of an acoustic wave using a capacitively coupled circuit having tunable electrical components.

### BACKGROUND

The background description provided is to present the context of the disclosure generally. Work of the inventors, to the extent it may be described in this background section, and aspects of the description that may not otherwise qualify as prior art at the time of filing, are neither expressly nor impliedly admitted as prior art against the present technology.

Sensing the incident angle of acoustic waves is required for many applications, such as applications involving the localization of a sound source. Systems for sensing acoustic incident angle usually measure the difference in acoustic wave arrival time, or phase difference, at two or more spaced-apart microphones. A significant disadvantage of this approach is that it generally requires a substantial distance between the multiple microphones, making it difficult to use a compact design. Thus, such phase-difference acoustic direction sensing systems are difficult to adapt to applications requiring or benefiting from a small size.

### SUMMARY

This section generally summarizes the disclosure and is not a comprehensive explanation of its full scope or all its features.

In one embodiment, a system comprises a first circuit and a second circuit capacitively coupled by a coupling capacitor, wherein the first circuit and the second circuit each comprise an inductor, a capacitor, and a resistor forming a frequency-selective network. A first acoustic transducer is coupled to the first circuit and a second acoustic transducer is coupled to the second circuit. At least one electrical element of the first circuit, at least one electrical element of the second circuit, or the coupling capacitor is a tunable electrical element configured to alter at least one of a resonance frequency, a bandwidth, or a damping characteristic of the first circuit or the second circuit. The first circuit and the second circuit generate respective output voltages that differ as a function of an incident angle of an acoustic wave.

In another embodiment, a method comprises receiving a first voltage from a first circuit connected to a first transducer and a second voltage from a second circuit connected to a second transducer, wherein the first circuit and the second circuit are capacitively coupled by a coupling capacitor. The method further comprises tuning at least one electrical element of at least one of the first circuit, the second circuit, or the coupling capacitor to alter at least one of a resonance frequency, a bandwidth, or a damping characteristic of the first circuit or the second circuit, and determining a direction of an acoustic wave detected by the first transducer and the second transducer based on the first voltage and the second voltage.

In another embodiment, a tunable capacitively coupled circuit comprises a first circuit comprising an inductor, a resistor, and a capacitor, the first circuit configured to be connected to a first transducer, and a second circuit comprising an inductor, a resistor, and a capacitor, the second circuit configured to be connected to a second transducer and capacitively coupled to the first circuit by a coupling capacitor. At least one tunable electrical element comprises at least one of the inductor, the resistor, or the capacitor of the first circuit, at least one of the inductor, the resistor, or the capacitor of the second circuit, or the coupling capacitor, wherein the at least one tunable electrical element is configurable to alter at least one of a resonance frequency, a bandwidth, or a damping characteristic of the first circuit or the second circuit.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates an example of a system for determining the direction of an acoustic wave using a capacitively coupled circuit having tunable elements.

FIG. 2 illustrates a more detailed view of the capacitively coupled circuit having tunable elements of FIG. 1.

FIG. 3 illustrates a more detailed view of the data acquisition system for use with the system for determining the direction of the acoustic wave of FIG. 1.

FIG. 4 illustrates a method for determining the direction of an acoustic wave using a capacitively coupled circuit having tunable elements.

FIGS. 5A-5D and 6A-6D illustrate frequency spectra of respective output voltages generated by the capacitively coupled circuit when different electrical elements are tuned to alter at least one of a resonance frequency, a bandwidth, or a damping characteristic, thereby modifying frequency response and contrast between the respective output voltages as a function of incident angle.

FIGS. 7A-7C illustrate surface plots of output voltage ratio as a function of incident angle and frequency for different coupling capacitor values, demonstrating changes in bandwidth and angular sensitivity resulting from tuning of the coupling capacitor.

FIGS. 8A-8C illustrate frequency spectra of respective output voltages and a corresponding surface plot for an increased resistor value, demonstrating modification of a damping characteristic that broadens resonance behavior and reduces contrast in output voltage ratio as a function of incident angle.

### DETAILED DESCRIPTION

Described herein are systems and methods for tunable acoustic direction sensing using a capacitively coupled circuit architecture. In general, a first circuit and a second circuit are capacitively coupled to one another, with a respective acoustic transducer associated with each circuit. When an acoustic wave is sensed by the transducers, electrical signals are produced and processed by the coupled circuits such that respective output voltages differ as a function of the incident angle of the acoustic wave. The direction of the acoustic wave may be determined by evaluating a relationship between the respective output voltages.

At least one tunable electrical element may be incorporated within the first circuit, the second circuit, and/or a coupling capacitor that capacitively couples the first circuit and the second circuit. Adjustment of the tunable electrical element may alter at least one of a resonance frequency, a bandwidth, or a damping characteristic of the coupled circuits, thereby modifying directional sensing behavior. Such tunability permits reconfiguration of an operating frequency range and directional response characteristics to accommodate different acoustic environments, operating conditions, or application requirements.

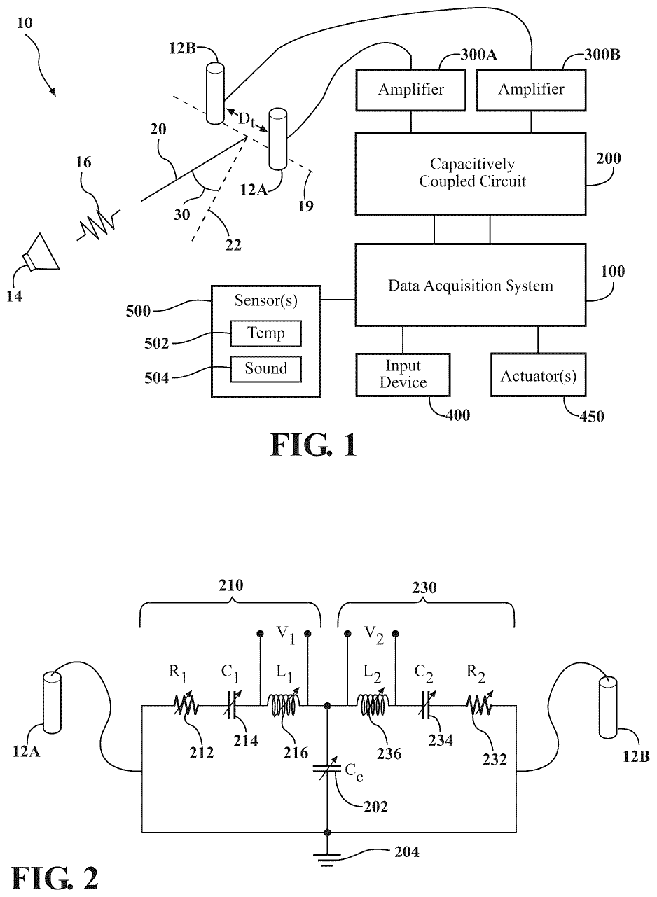

Referring to FIG. 1, illustrated is one example of a system 10 for determining a direction 30 of an acoustic wave 16 generated by a source 14, such as a speaker or other device capable of emitting acoustic energy. The system 10 includes a first acoustic transducer 12A and a second acoustic transducer 12B separated by a known distance Dₜ. A line 19 may be defined between the first acoustic transducer 12A and the second acoustic transducer 12B to represent the spacing between the transducers. A line 22 extends generally perpendicular to the line 19 from a location corresponding to a midpoint between the first acoustic transducer 12A and the second acoustic transducer 12B and provides a reference direction for evaluating an angle of arrival of the acoustic wave 16. A line 20 represents a propagation path of the acoustic wave 16 toward the first acoustic transducer 12A and the second acoustic transducer 12B. The direction 30 corresponds to an incident angle formed between the line 20 and the line 22. As described in greater detail below, the direction 30 may be determined by calculating a ratio between respective output voltages generated by a capacitively coupled circuit 200 and mapping the ratio to a corresponding direction 30.

The transducers 12A and 12B are configured to convert acoustic energy associated with the acoustic wave 16 into corresponding electrical signals. In one example, the transducers 12A and 12B are microphones that generate electrical signals responsive to pressure variations of the acoustic wave 16. The electrical signals are provided to the capacitively coupled circuit 200. In certain embodiments, the transducers 12A and 12B may be micro-electro-mechanical system microphones that include movable diaphragms responsive to the acoustic wave 16 and configured to generate corresponding electrical signals.

In some embodiments, the electrical signals generated by the transducers 12A and 12B may be amplified by a first amplifier 300A and a second amplifier 300B, respectively, prior to being supplied to the capacitively coupled circuit 200. The amplifiers 300A and 300B may increase signal amplitude such that the signals supplied to the capacitively coupled circuit 200 are suitable for subsequent processing.

The capacitively coupled circuit 200 includes circuit portions that are capacitively coupled to one another via a coupling capacitor. This capacitive coupling electrically couples the circuit portions for alternating-current signaling while inhibiting direct current coupling between the circuit portions. As will be explained in greater detail later, the capacitively coupled circuit 200 may include one or more tunable electrical elements. At least one electrical element of the capacitively coupled circuit 200 may be adjustable to alter at least one of a resonance frequency, a bandwidth, or a damping characteristic.

In embodiments in which one or more electrical elements are electronically tunable, the system 10 may include actuator(s) 450 configured to adjust the tunable electrical elements. The actuator(s) 450 may be controlled by the data acquisition system 100 to modify one or more electrical parameters of the capacitively coupled circuit 200. The actuator(s) 450 may include, for example, electronically controlled variable components, switched networks, motor-driven mechanical adjusters, or other mechanisms capable of altering inductance, capacitance, resistance, or coupling characteristics.

In certain embodiments, the system 10 may further include the input device 400 configured to permit user specification of one or more operating characteristics, such as a target resonance frequency or a target operating frequency range. In some embodiments, the system 10 may additionally and/or alternatively include one or more sensor(s) 500. The sensor(s) 500 may include, for example, the temperature sensor 502 and/or the sound sensor 504. In some embodiments, the temperature sensor 502 is configured to detect an ambient temperature. In some embodiments, the sound sensor 504 may be a separate acoustic sensor configured to detect at least one of a sound frequency variation or an ambient acoustic condition. The sensor(s) 500 may provide environmental information that is used to determine adjustment of one or more tunable electrical elements through the actuator(s) 450.

In some embodiments, the sound sensor 504 is implemented using at least one of the transducers 12A and 12B rather than a separate sensor. For example, an electrical signal generated by the first acoustic transducer 12A and/or the second acoustic transducer 12B, optionally after amplification by the first amplifier 300A and/or the second amplifier 300B, may be branched into a first signal path provided to the capacitively coupled circuit 200 and a second signal path provided to the data acquisition system 100. In the second signal path, the processor(s) 110 may process the signal to determine frequency content associated with an ambient acoustic condition and to generate, based on the determined frequency content, a tuning decision for at least one tunable electrical element of at least one of the first circuit 210, the second circuit 230, or the coupling capacitor 202 (C_{C}). In such embodiments, the second signal path may bypass the capacitively coupled circuit 200 such that frequency analysis of the electrical signal generated by at least one of the transducers 12A or 12B is performed independently of the first circuit 210 and the second circuit 230.

The actuator(s) 450, the input device 400, and the sensor(s) 500 are optional components. In configurations where the tunable electrical elements are manually adjustable, the system 10 may omit the actuator(s) 450, the input device 400, and/or the sensor(s) 500. In other configurations, the actuator(s) 450 may be present with or without the input device 400 and/or the sensor(s) 500. Accordingly, the presence and arrangement of the actuator(s) 450, the input device 400, and the sensor(s) 500 may vary depending on how the tunable electrical elements are implemented and controlled.

FIG. 2 illustrates one example of the capacitively coupled circuit 200. In this example, the capacitively coupled circuit 200 includes a first circuit 210 and a second circuit 230 that are capacitively coupled to one another via a coupling capacitor 202 (C_{C}). The coupling capacitor 202 (C_{C}) capacitively couples the first circuit 210 and the second circuit 230 and inhibits direct current coupling between the first circuit 210 and the second circuit 230. The first acoustic transducer 12A is coupled to the first circuit 210 and the second acoustic transducer 12B is coupled to the second circuit 230.

The first circuit 210 may include a resistor 212 (R₁), a capacitor 214 (C₁), and an inductor 216 (L₁) arranged as a first frequency-selective network. In one example, the resistor 212 (R₁), the capacitor 214 (C₁), and the inductor 216 (L₁) are connected in series, wherein the inductor 216 (L₁) is coupled to the coupling capacitor 202 (C_{C}) and the resistor 212 (R₁) is coupled to ground 204. The second circuit 230 may include a resistor 232 (R₂), a capacitor 234 (C₂), and an inductor 236 (L₂) arranged as a second frequency-selective network. In one example, the resistor 232 (R₂), the capacitor 234 (C₂), and the inductor 236 (L₂) are connected in series, wherein the inductor 236 (L₂) is coupled to the coupling capacitor 202 (C_{C}) and the resistor 232 (R₂) is coupled to ground 204. Together, the first frequency-selective network and the second frequency-selective network produce respective output voltages V₁ and V₂ in response to electrical signals received from the first acoustic transducer 12A and the second acoustic transducer 12B. In one embodiment, the coupling capacitor 202 (C_{C}) has a capacitance greater than a capacitance of the capacitor 214 (C₁) and a capacitance of the capacitor 234 (C₂). In some embodiments, at least one parameter of a resistor, a capacitor, and an inductor of the first circuit 210 is substantially equal to at least one parameter of a resistor, a capacitor, and an inductor of the second circuit 230.

The output voltages V₁ and V₂ may be measured across the inductor 216 (L₁) and the inductor 236 (L₂), respectively, although other measurement locations may be used depending on implementation. The output voltages V₁ and V₂ have frequency-dependent magnitudes, and due to interaction between the first circuit 210 and the second circuit 230 through the coupling capacitor 202 (C_{C}), the output voltages V₁ and V₂ differ as a function of an incident angle of the acoustic wave 16.

At least one electrical element of the first circuit 210, the second circuit 230, and/or the coupling capacitor 202 (C_{C}) may be a tunable electrical element. The tunable electrical element may be mechanically adjustable, electronically controllable, digitally controllable, implemented using a variable impedance device, implemented using a switched component network, or implemented using another mechanism capable of altering inductance, capacitance, resistance, or coupling. For example, at least one of the capacitor 214 (C₁), the inductor 216 (L₁), the capacitor 234 (C₂), or the inductor 236 (L₂) may be tunable to shift a resonance frequency of at least one of the first frequency-selective network or the second frequency-selective network. As another example, at least one of the resistor 212 (R₁) or the resistor 232 (R₂) may be tunable to adjust a damping characteristic that modifies a contrast between the output voltages V₁ and V₂ as a function of the incident angle of the acoustic wave 16. As another example, the coupling capacitor 202 (C_{C}) may be tunable to adjust a bandwidth of an operating frequency range over which the output voltages V₁ and V₂ differ as a function of the incident angle of the acoustic wave 16.

Any combination of the electrical elements may be tunable. In some embodiments, a single electrical element is tunable while remaining electrical elements are fixed. In other embodiments, multiple electrical elements are independently tunable, including independent tunability of corresponding electrical elements in the first circuit 210 and the second circuit 230. In further embodiments, all of the electrical elements of the capacitively coupled circuit 200 are tunable.

When the acoustic wave 16 is detected by the first acoustic transducer 12A and the second acoustic transducer 12B, respective electrical signals are provided to the first circuit 210 and the second circuit 230. Interaction between the first circuit 210 and the second circuit 230 through the coupling capacitor 202 (C_{C}) produces respective output voltages V₁ and V₂ that differ as a function of the incident angle of the acoustic wave 16. The output voltages V₁ and V₂ are provided to the data acquisition system 100, which evaluates a relationship between V₁ and V₂, such as a ratio between V₁ and V₂, and determines the direction 30 of the acoustic wave 16 based on the evaluated relationship.

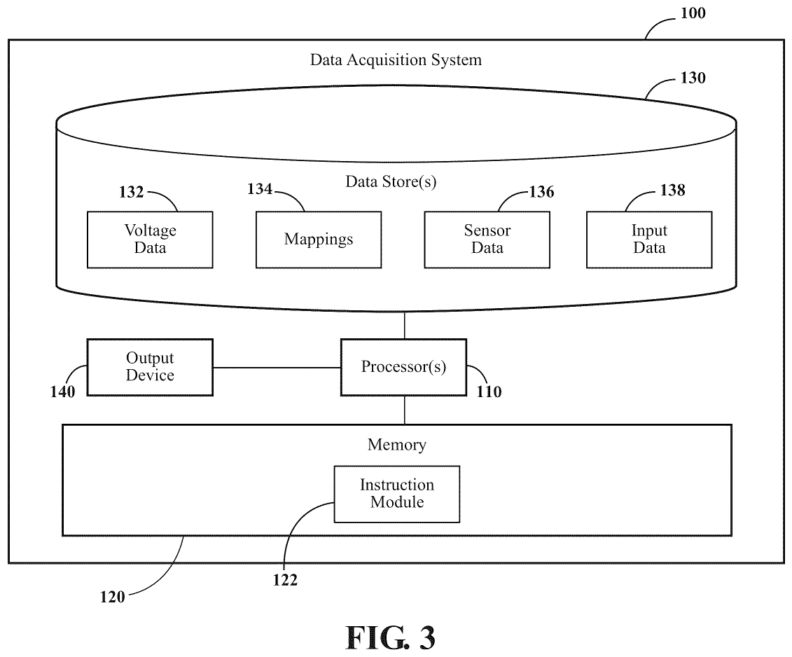

FIG. 3 illustrates a more detailed view of one example of the data acquisition system 100 configured to determine the direction 30 of the acoustic wave 16 shown in FIG. 1. The illustrated data acquisition system 100 represents one possible implementation. The data acquisition system 100 may include additional components, fewer components, or different components than those shown, depending on system configuration.

In one embodiment, the data acquisition system 100 includes one or more processor(s) 110. The processor(s) 110 may be integrated within the data acquisition system 100 or may be communicatively coupled through a data bus or other communication path. The processor(s) 110 may include one or more microprocessors, microcontrollers, digital signal processors, field programmable gate arrays, application-specific integrated circuits, or other electronic processing devices capable of executing instructions and performing signal processing operations described herein.

The data acquisition system 100 may further include a memory 120 in communication with the processor(s) 110. The memory 120 may include volatile memory, non-volatile memory, or a combination thereof, including random-access memory (RAM), read-only memory (ROM), flash memory, solid-state storage, magnetic storage, or other suitable non-transitory storage media. The memory 120 may store an instruction module 122 comprising computer-readable instructions that, when executed by the processor(s) 110, cause the processor(s) 110 to perform operations associated with determining the direction 30 of the acoustic wave 16.

In one embodiment, the data store(s) 130 may include voltage data 132 corresponding to output voltages V₁ and V₂ generated by the capacitively coupled circuit 200. When the transducers 12A and 12B detect the acoustic wave 16, electrical signals are generated, optionally amplified by the amplifiers 300A and 300B, and supplied to the first circuit 210 and the second circuit 230. This interaction produces respective output voltages V₁ and V₂, which may be sampled and stored as corresponding pairs in the voltage data 132. The voltage data 132 may include instantaneous voltage values, sampled voltage magnitudes, averaged values, filtered values, or other processed representations of V₁ and V₂.

The data store(s) 130 may further include mappings 134. The mappings 134 may implement a mapping that maps a relationship of V₁ and V₂, including a ratio between V₁ and V₂, to a mapped direction. In some embodiments, the mapped direction corresponds to the direction 30 of the acoustic wave 16. The mappings 134 may be implemented as a lookup table, calibration table, mathematical function, algorithmic model, interpolation scheme, or other association between the relationship of V₁ and V₂ and the mapped direction. The mappings 134 may be established through calibration, simulation, empirical measurement, or other characterization processes.

In embodiments in which the system 10 includes one or more sensor(s) 500, the data store(s) 130 may also include sensor data 136. The sensor data 136 may correspond to environmental measurements obtained from the sensor(s) 500, including, for example, temperature data from temperature sensor 502 and/or acoustic condition data from sound sensor 504. The sensor data 136 may be used by the processor(s) 110 to adjust one or more tunable electrical elements of the capacitively coupled circuit 200 and/or to modify how voltage relationships are interpreted.

In embodiments in which the system 10 includes an input device 400, the data store(s) 130 may further include input data 138. The input data 138 may correspond to user-provided configuration parameters, such as a selected operating frequency range, a desired resonance frequency, or other tuning-related inputs. The input data 138 may be used to control adjustment of one or more tunable electrical elements.

The inclusion of sensor data 136 and input data 138 is optional. In configurations where tunable electrical elements are manually adjusted and no electronic control is performed, the data store(s) 130 may omit sensor data 136 and/or input data 138. Accordingly, the structure and contents of the data store(s) 130 may vary depending on system configuration and implementation.

The data acquisition system 100 may further include an output device 140 in communication with the processor(s) 110. The output device 140 may be configured to present, transmit, or otherwise utilize the determined direction 30 of the acoustic wave 16. The output device 140 may include, for example, a display, user interface, communication interface, control interface, or other device capable of conveying the determined direction 30 to a user or to another system.

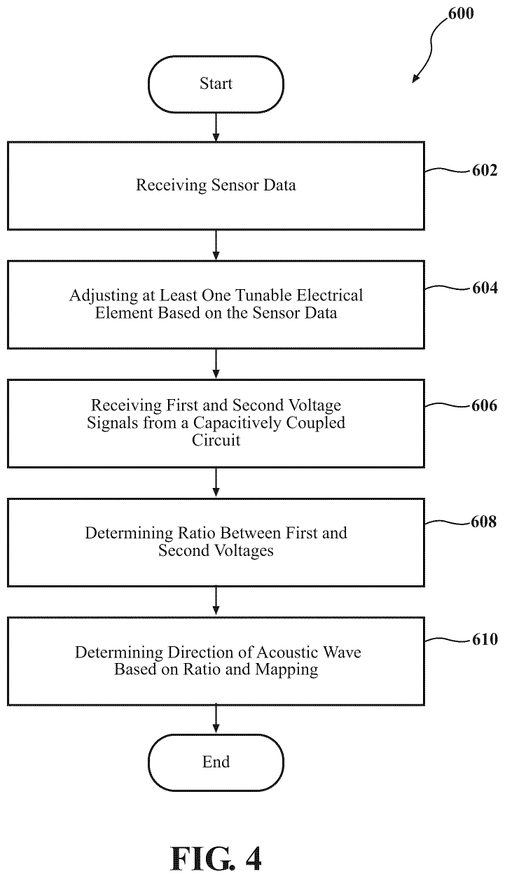

The instruction module 122 may include computer-readable instructions that, when executed by the processor(s) 110, cause the processor(s) 110 to perform one or more methodologies described herein. With reference to FIG. 4, a method 600 for determining the direction 30 of the acoustic wave 16 using the capacitively coupled circuit 200 is illustrated. The method 600 is described from the perspective of the data acquisition system 100 for purposes of explanation. However, the method 600 is not limited to implementation within the data acquisition system 100 and may be implemented in other suitable systems. In one embodiment, the method 600 is embodied as processor-executable instructions stored in the instruction module 122 and executed by the processor(s) 110.

In step 602, the instruction module 122 includes instructions that, when executed by the processor(s) 110, cause the processor(s) 110 to receive sensor data 136 from the sensor(s) 500. The sensor(s) 500 may include the temperature sensor 502 configured to detect an ambient temperature and/or the sound sensor 504 configured to detect a sound frequency variation, although other sensor(s) may also be utilized. The sensor data 136 may correspond to environmental conditions associated with operation of the system 10. As will be explained in greater detail below, the received sensor data 136 may be used to determine appropriate adjustment of one or more tunable electrical elements of the capacitively coupled circuit 200. In embodiments in which the tunable electrical elements are manually adjustable and/or adjusted through the input device 400, step 602 may be omitted.

In step 604, the instruction module 122 includes instructions that, when executed by the processor(s) 110, cause the processor(s) 110 to determine an adjustment of at least one tunable electrical element of at least one of the first circuit 210, the second circuit 230, or the coupling capacitor 202 (C_{C}), and to generate control signals for actuator(s) 450 configured to implement the determined adjustment. The adjustment may be determined based on at least one of the sensor data 136, input data 138 received via the input device 400, calibration data stored in the data store(s) 130, or other control logic executed by the processor(s) 110, and may be performed to alter at least one of a resonance frequency, a bandwidth, or a damping characteristic of the first circuit 210 or the second circuit 230.

In embodiments in which the sensor data 136 includes ambient temperature data from the temperature sensor 502, the processor(s) 110 may determine that one or more electrical characteristics of the capacitively coupled circuit 200 have shifted or may shift due to temperature-dependent behavior of circuit components. For example, inductance, capacitance, and resistance values may vary as a function of temperature. The processor(s) 110 may compensate for such variation by determining an adjusted target resonance frequency, bandwidth, and/or damping characteristic. The adjustment may be determined using a predefined compensation table, calibration data stored in the data store(s) 130, or an algorithmic relationship between temperature and electrical parameter variation.

In embodiments in which the sensor data 136 includes sound frequency variation data from the sound sensor 504, the processor(s) 110 may analyze characteristics of the ambient acoustic environment, including dominant frequency content, frequency distribution, amplitude levels, or noise characteristics. Based on this analysis, the processor(s) 110 may determine a desired operating frequency range or resonance condition that improves directional discrimination under current acoustic conditions. For example, the processor(s) 110 may determine tuning parameters that shift a resonance frequency toward a detected dominant frequency band and/or adjust a bandwidth to improve contrast between the output voltages V₁ and V₂ as a function of the incident angle of the acoustic wave 16.

In some embodiments, the capacitively coupled circuit 200 operates in a resonance-based sensing mode in which directional discrimination is increased in a resonance region defined by the first frequency-selective network and the second frequency-selective network. In such embodiments, when a target acoustic wave 16 includes dominant frequency content that is offset from a current resonance frequency of at least one of the first circuit 210 or the second circuit 230, the processor(s) 110 may determine that the target acoustic wave 16 is off resonance and may automatically tune at least one tunable electrical element to shift the resonance frequency toward the dominant frequency content. After such tuning, the processor(s) 110 may determine the direction 30 based on the first voltage V₁ and the second voltage V₂ under the adjusted resonance condition.

After determining one or more desired electrical characteristics, the processor(s) 110 may transmit control signals to the actuator(s) 450 associated with the tunable electrical element(s). The actuator(s) 450 may adjust an inductance of the inductor 216 (L₁) and/or the inductor 236 (L₂), a capacitance of the capacitor 214 (C₁) and/or the capacitor 234 (C₂), a resistance of the resistor 212 (R₁) and/or the resistor 232 (R₂), and/or a capacitance of the coupling capacitor 202 (C_{C}). The actuator(s) 450 may be implemented as electronically controlled variable components, switched networks, variable impedance devices, motor-driven mechanisms, or other adjustable elements.

In this manner, the processor(s) 110 may adjust at least one tunable electrical element to alter at least one of a resonance frequency, a bandwidth, or a damping characteristic of the first circuit 210 or the second circuit 230. In some embodiments, the processor(s) 110 automatically adjusts the tunable electrical element without user input based on at least one detected environmental condition comprising at least one of a sound frequency variation or an ambient temperature. In some embodiments, the processor(s) 110 adjusts the tunable electrical element in response to a user input received via the input device 400 that specifies at least one of a target resonance frequency or a target operating frequency range. In configurations in which tuning is manual, at least one of the capacitor 214 (C₁), the capacitor 234 (C₂), the inductor 216 (L₁), the inductor 236 (L₂), the resistor 212 (R₁), the resistor 232 (R₂), or the coupling capacitor 202 (C_{C}) may be mechanically adjusted, and the actuator(s) 450 may be omitted.

In some manual-tuning embodiments, at least one tunable electrical element comprises a user-adjustable component having a mechanical adjustment interface. For example, at least one of the resistor 212 (R₁) or the resistor 232 (R₂) may be implemented as a variable resistor adjusted by a tuning knob, and/or at least one of the capacitor 214 (C₁), the capacitor 234 (C₂), or the coupling capacitor 202 (C_{C}) may be implemented as a variable capacitor adjusted by a mechanical adjustment interface. In such embodiments, tuning may be performed without electronic control by the processor(s) 110, and the actuator(s) 450 and the input device 400 may be omitted.

In step 606, the instruction module 122 includes instructions that, when executed by the processor(s) 110, cause the processor(s) 110 to receive a first voltage V₁ from the first circuit 210 connected to the first acoustic transducer 12A and a second voltage V₂ from the second circuit 230 connected to the second acoustic transducer 12B, wherein the first circuit 210 and the second circuit 230 are capacitively coupled by the coupling capacitor 202 (C_{C}). In some embodiments, the first voltage V₁ and the second voltage V₂ are received directly from the capacitively coupled circuit 200. In other embodiments, the first voltage V₁ and the second voltage V₂ may be retrieved from the data store(s) 130, where they are stored as voltage data 132.

The first voltage V₁ may correspond to a voltage measured across the inductor 216 (L₁) of the first circuit 210, and the second voltage V₂ may correspond to a voltage measured across the inductor 236 (L₂) of the second circuit 230, although other measurement locations may be used depending on implementation. The first voltage V₁ and the second voltage V₂ may be acquired as corresponding pairs measured at substantially the same time or within a defined sampling interval. In some embodiments, the voltages V₁ and V₂ may be sampled, digitized, filtered, averaged, or otherwise conditioned prior to evaluation.

The received first voltage V₁ and second voltage V₂ represent electrical responses of the capacitively coupled circuit 200 to the acoustic wave 16 detected by the transducers 12A and 12B. The processor(s) 110 may utilize the received voltages V₁ and V₂ in subsequent steps to determine the direction 30 of the acoustic wave 16.

In step 608, the instruction module 122 includes instructions that, when executed by the processor(s) 110, cause the processor(s) 110 to determine a ratio between the first voltage V₁ and the second voltage V₂. In one embodiment, the ratio is determined by dividing V₁ by V₂. In another embodiment, the ratio is determined by dividing V₂ by V₁. The selected ratio representation may depend on calibration convention or mapping implementation.

In some embodiments, the processor(s) 110 may determine the ratio using instantaneous voltage values. In other embodiments, the processor(s) 110 may determine the ratio using processed representations of V₁ and V₂, including sampled magnitudes, averaged values, filtered values, peak values, root-mean-square values, or other derived quantities. The ratio may be computed at a selected frequency, across a defined frequency band, or over a selected time interval.

In step 610, the instruction module 122 includes instructions that, when executed by the processor(s) 110, cause the processor(s) 110 to determine the direction 30 of the acoustic wave 16 based on the determined ratio and the mappings 134. In one embodiment, the mappings 134 implement a mapping that maps the determined ratio to a mapped direction corresponding to the direction 30. The mappings 134 may include a reference table, lookup table, calibration dataset, mathematical function, algorithmic model, interpolation scheme, or other association between a voltage ratio and a mapped direction.

The mappings 134 may be established through calibration, simulation, empirical measurement, or other characterization procedures performed in a controlled setting in which known directions 30 are associated with corresponding ratios between V₁ and V₂. The processor(s) 110 may access the mappings 134 to translate the determined ratio into the mapped direction and thereby determine the direction 30 of the acoustic wave 16. After determining the direction 30, the processor(s) 110 may cause the direction 30 to be provided to the output device 140.

After determining the direction 30 of the acoustic wave 16 in step 610, the instruction module 122 may include instructions that, when executed by the processor(s) 110, cause the processor(s) 110 to provide the determined direction 30 to the output device 140. The output device 140 may present, transmit, or otherwise utilize the determined direction 30.

Following determination and optional output of the direction 30, the method 600 may proceed to an end state. In some embodiments, the method 600 may be performed once in response to a detected acoustic event. In other embodiments, one or more of steps 602 through 610 may be repeated continuously, periodically, or in response to changing environmental conditions such that the direction 30 is updated in real time or near real time. The order of the steps illustrated in FIG. 4 is provided for purposes of explanation, and one or more steps may be performed in a different order, performed concurrently, repeated, or omitted depending on system configuration. For example, tuning of at least one tunable electrical element in step 604 may be performed before receiving the first voltage V₁ and the second voltage V₂ in step 606, after receiving the first voltage V₁ and the second voltage V₂ in step 606, and/or iteratively while receiving the first voltage V₁ and the second voltage V₂.

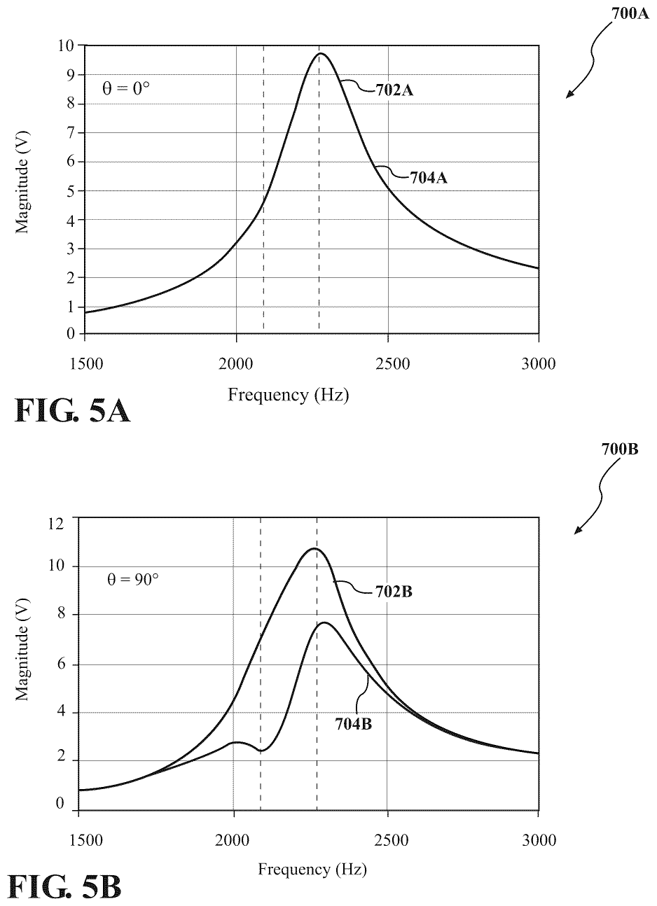

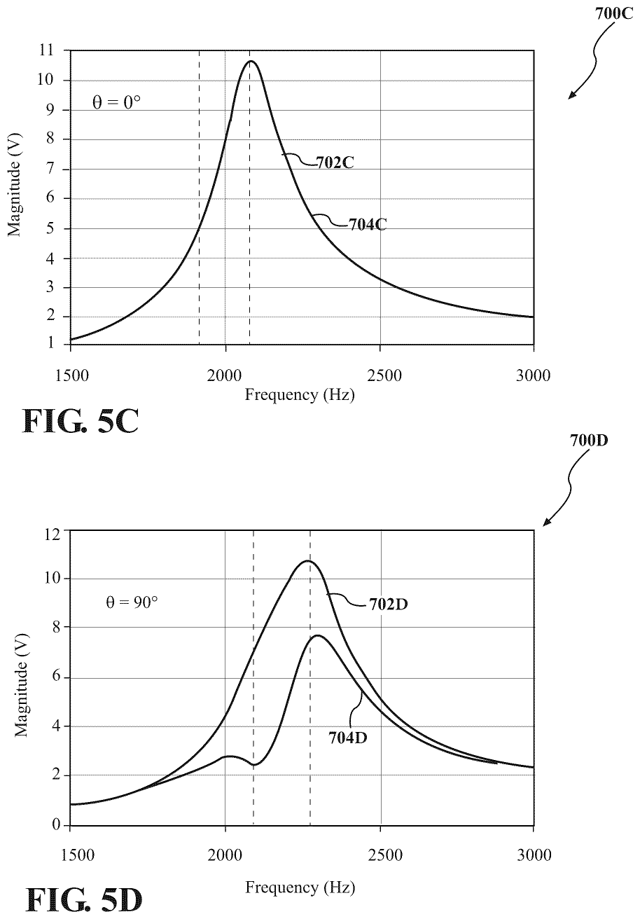

In FIGS. 5A and 5B, illustrated are plots 700A and 700B showing voltage magnitude as a function of frequency for the capacitively coupled circuit 200 including the first circuit 210 and the second circuit 230 under a first tuning configuration. In this configuration, the inductor 216 (L₁) of the first circuit 210 and the inductor 236 (L₂) of the second circuit 230 each have an inductance of L₀, the capacitor 214 (C₁) of the first circuit 210 and the capacitor 234 (C₂) of the second circuit 230 each have a capacitance of C₀, the coupling capacitor 202 (C_{C}) has a capacitance of 5*C₀, and the resistor 212 (R₁) of the first circuit 210 and the resistor 232 (R₂) of the second circuit 230 each have a resistance of R₀. The first circuit 210 and the second circuit 230 are therefore symmetrically tuned.

In FIG. 5A, the acoustic wave is incident at 0 degrees. The plot 700A includes a first trace 702A corresponding to a first output voltage V₁ generated by the first circuit 210 and a second trace 704A corresponding to a second output voltage V₂ generated by the second circuit 230. Under this condition, the first trace 702A and the second trace 704A substantially overlap across the resonance region defined by the inductors 216 (L₁), 236 (L₂) and the capacitors 214 (C₁), 234 (C₂), and influenced by the coupling capacitor 202 (C_{C}) having a capacitance of 5*C₀, such that V₁ and V₂ are substantially equal in magnitude and a ratio between V₁ and V₂ is approximately equal to one.

In FIG. 5B, the electrical parameters of the first circuit 210, the second circuit 230, and the coupling capacitor 202 (C_{C}) remain unchanged, but the acoustic wave is incident at 90 degrees. The first trace 702B and the second trace 704B do not substantially overlap, and a separation is observed near the resonance frequency. The relative magnitudes of V₁ and V₂ therefore vary as a function of incident angle, and the ratio between V₁ and V₂ deviates from unity in the resonance region.

FIGS. 5C and 5D illustrate plots 700C and 700D under a second tuning configuration in which the inductors 216 (L₁) and 236 (L₂) each have an inductance of 1.2*L₀, while the capacitors 214 (C₁) and 234 (C₂) each remain C₀, the coupling capacitor 202 (C_{C}) remains 5*C₀, and the resistors 212 (R₁) and 232 (R₂) remain R₀. The first circuit 210 and the second circuit 230 therefore remain symmetrically tuned but at the increased inductance.

In FIG. 5C, the acoustic wave is incident at 0 degrees and the first trace 702C and the second trace 704C substantially overlap, but the resonance peak is shifted relative to FIG. 5A due to the increased inductance of the inductors 216 (L₁) and 236 (L₂). The ratio between V₁ and V₂ remains approximately equal to one under this condition.

In FIG. 5D, the acoustic wave is incident at 90 degrees and the first trace 702D and the second trace 704D do not substantially overlap. A separation is observed near the shifted resonance frequency, and the ratio between V₁ and V₂ therefore deviates from unity, demonstrating that directional information is preserved at the tuned resonance frequency defined by the inductors 216 (L₁), 236 (L₂) and the capacitors 214 (C₁), 234 (C₂), and influenced by the coupling capacitor 202 (C_{C}).

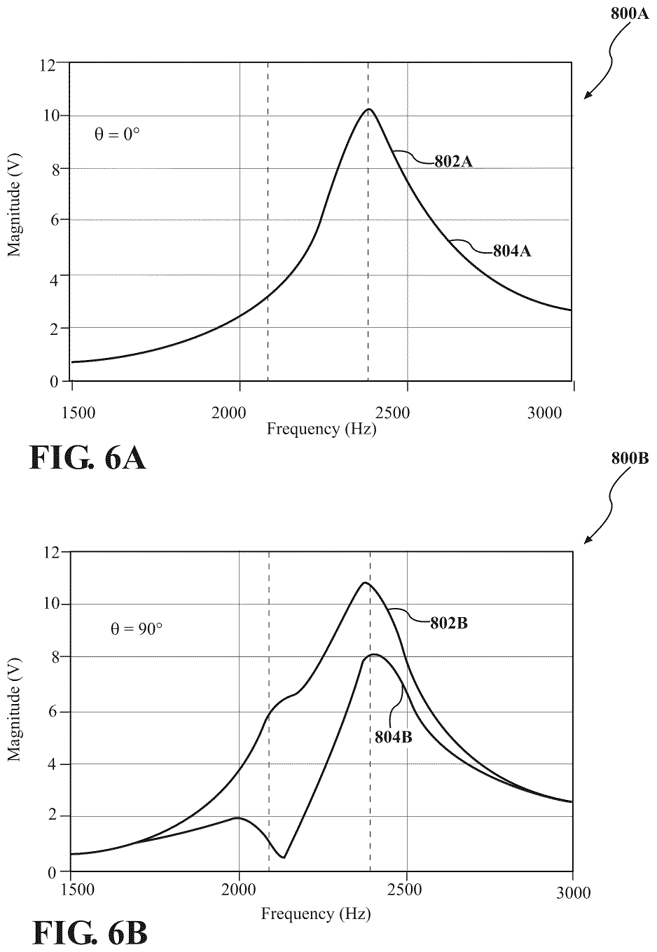

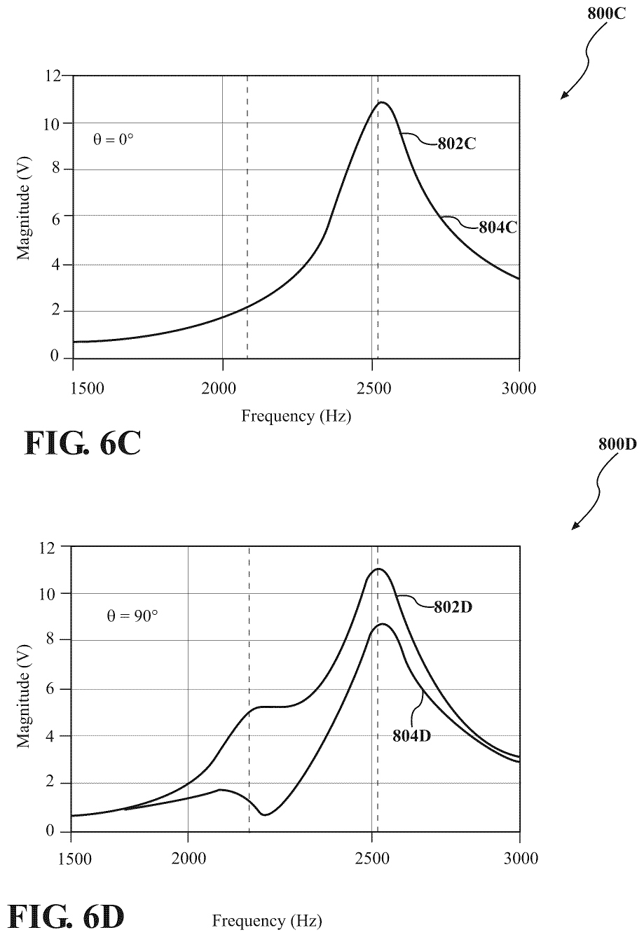

FIGS. 6A and 6B illustrate plots 800A and 800B showing voltage magnitude as a function of frequency for the capacitively coupled circuit 200 including the first circuit 210 and the second circuit 230 under a third tuning configuration. In this configuration, the inductor 216 (L₁) of the first circuit 210 and the inductor 236 (L₂) of the second circuit 230 each have an inductance of L₀, the capacitor 214 (C₁) of the first circuit 210 and the capacitor 234 (C₂) of the second circuit 230 each have a capacitance of C₀, the resistor 212 (R₁) and the resistor 232 (R₂) each have a resistance of R₀, and the coupling capacitor 202 (C_{C}) has a capacitance of 3*C₀. The first circuit 210 and the second circuit 230 therefore remain symmetrically tuned, while the capacitance of the coupling capacitor 202 (C_{C}) is reduced relative to FIGS. 5A and 5B.

In FIG. 6A, the acoustic wave is incident at 0 degrees. The plot 800A includes a first trace 802A corresponding to a first output voltage V₁ generated by the first circuit 210 and a second trace 804A corresponding to a second output voltage V₂ generated by the second circuit 230. Under this condition, the first trace 802A and the second trace 804A substantially overlap across the resonance region defined by the inductors 216 (L₁), 236 (L₂) and the capacitors 214 (C₁), 234 (C₂), and influenced by the coupling capacitor 202 (C_{C}) having a capacitance of 3*C₀, such that V₁ and V₂ are substantially equal in magnitude and a ratio between V₁ and V₂ is approximately equal to one.

In FIG. 6B, the electrical parameters of the first circuit 210, the second circuit 230, and the coupling capacitor 202 (C_{C}) remain unchanged, but the acoustic wave is incident at 90 degrees. The first trace 802B and the second trace 804B do not substantially overlap, and a separation is observed near the resonance frequency. The relative magnitudes of V₁ and V₂ therefore vary as a function of incident angle, and the ratio between V₁ and V₂ deviates from unity in the resonance region.

FIGS. 6C and 6D illustrate plots 800C and 800D under a fourth tuning configuration in which the inductors 216 (L₁) and 236 (L₂) each remain L₀, the capacitors 214 (C₁) and 234 (C₂) each remain C₀, the resistors 212 (R₁) and 232 (R₂) each remain R₀, and the coupling capacitor 202 (C_{C}) is further reduced to 2*C₀. Reducing the capacitance of the coupling capacitor 202 (C_{C}) decreases the coupling strength between the first circuit 210 and the second circuit 230, which correspondingly alters the bandwidth and sharpness of the resonance response.

In FIG. 6C, the acoustic wave is incident at 0 degrees and the first trace 802C and the second trace 804C substantially overlap, such that the ratio between V₁ and V₂ remains approximately equal to one.

In FIG. 6D, the acoustic wave is incident at 90 degrees and the first trace 802D and the second trace 804D do not substantially overlap. A separation is observed near the resonance region influenced by the reduced capacitance of the coupling capacitor 202 (C_{C}), and the ratio between V₁ and V₂ therefore deviates from unity, demonstrating that directional information is maintained as the capacitance of the coupling capacitor 202 (C_{C}) is adjusted.

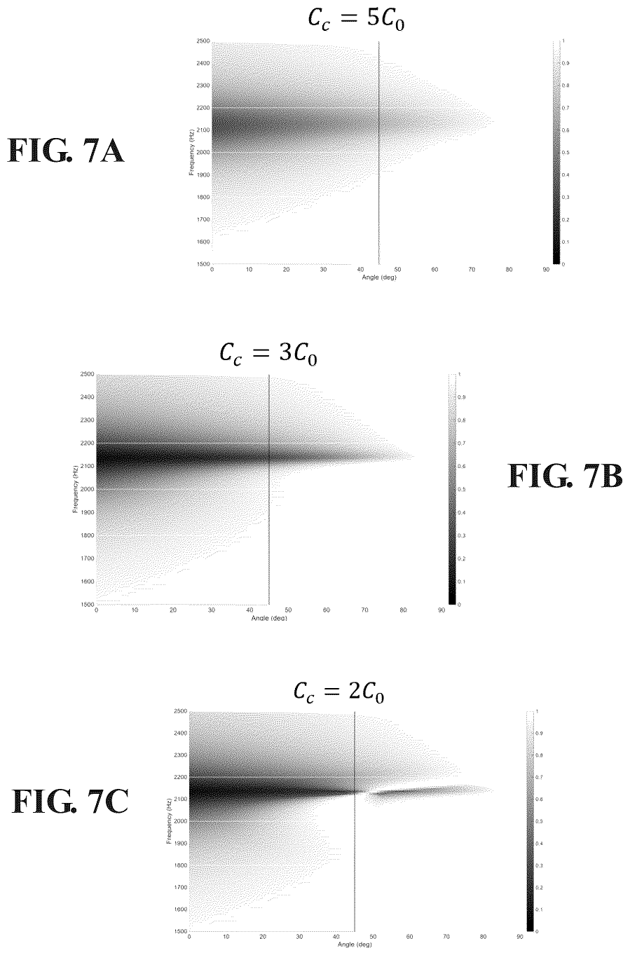

FIGS. 7A-7C illustrate surface plots showing a ratio V₁/V₂ between the first output voltage V₁ generated by the first circuit 210 and the second output voltage V₂ generated by the second circuit 230 as a function of frequency and incident angle of the acoustic wave. In each plot, one axis represents frequency, another axis represents incident angle, and a color scale represents a magnitude of the ratio V₁/V₂. Although the ratio V₁/V₂ is illustrated, an inverse ratio V₂/V₁ may alternatively be utilized with a corresponding mapping implementation.

In FIG. 7A, the inductors 216 (L₁) and 236 (L₂) each have an inductance of L₀, the capacitors 214 (C₁) and 234 (C₂) each have a capacitance of C₀, the resistors 212 (R₁) and 232 (R₂) each have a resistance of R₀, and the coupling capacitor 202 (C_{C}) has a capacitance of 5*C₀. The surface plot shows that the ratio V₁/V₂ varies as a function of incident angle, with the most pronounced variation occurring in the resonance region.

In FIG. 7B, the electrical parameters of the first circuit 210 and the second circuit 230 remain L₀, C₀, and R₀, but the capacitance of the coupling capacitor 202 (C_{C}) is reduced to 3*C₀. The resulting surface plot demonstrates a change in the angular dependence and frequency bandwidth of the ratio V₁/V₂ due to the reduced coupling between the first circuit 210 and the second circuit 230.

In FIG. 7C, the capacitance of the coupling capacitor 202 (C_{C}) is further reduced to 2*C₀, while the remaining electrical parameters remain unchanged. The surface plot illustrates a further modification of the resonance bandwidth and angular sensitivity of the ratio V₁/V₂, demonstrating that adjustment of the capacitance of the coupling capacitor 202 (C_{C}) enables tuning of directional response characteristics across frequency and angle.

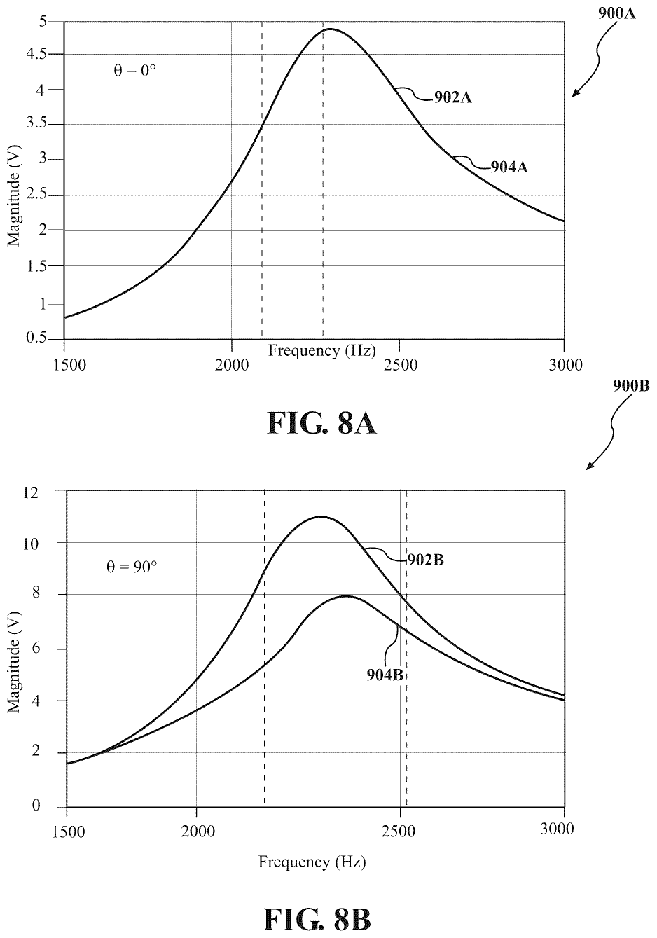

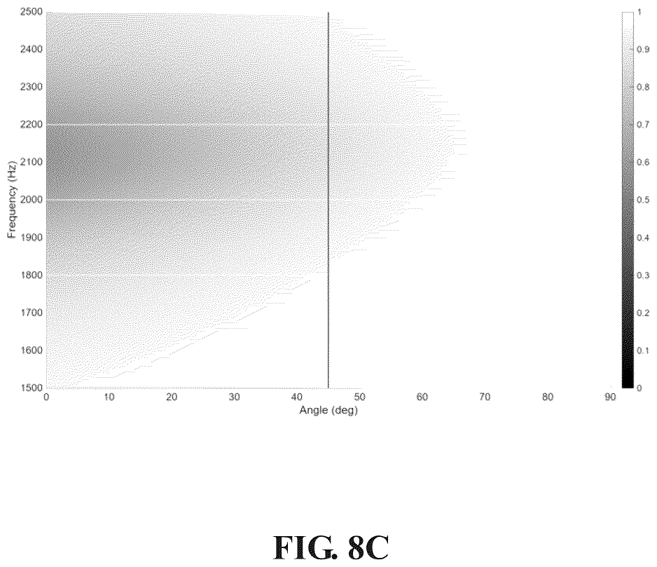

FIGS. 8A and 8B illustrate plots 900A and 900B showing voltage magnitude as a function of frequency for the capacitively coupled circuit 200 including the first circuit 210 and the second circuit 230 under a fifth tuning configuration in which the inductors 216 (L₁) and 236 (L₂) each have an inductance of L₀, the capacitors 214 (C₁) and 234 (C₂) each have a capacitance of C₀, the coupling capacitor 202 (C_{C}) has a capacitance of 5*C₀, and the resistor 212 (R₁) of the first circuit 210 and the resistor 232 (R₂) of the second circuit 230 each have a resistance of 2*R₀. Increasing the resistances relative to R₀ increases damping of the resonance response.

In FIG. 8A, the acoustic wave is incident at 0 degrees. The plot 900A includes a first trace 902A corresponding to a first output voltage V₁ generated by the first circuit 210 and a second trace 904A corresponding to a second output voltage V₂ generated by the second circuit 230. Under this condition, the first trace 902A and the second trace 904A substantially overlap, but the resonance peak is broader and less sharp than in FIG. 5A due to the increased damping produced by the resistors 212 (R₁) and 232 (R₂) having resistances of 2*R₀.

In FIG. 8B, the electrical parameters remain unchanged, but the acoustic wave is incident at 90 degrees. The first trace 902B and the second trace 904B do not substantially overlap, and a separation is observed near the resonance region. Although the resonance peak is broader due to the increased resistances, the ratio between V₁ and V₂ deviates from unity at 90 degrees, demonstrating that directional information is preserved under increased damping conditions.

FIG. 8C illustrates a surface plot showing the ratio between the first output voltage V₁ generated by the first circuit 210 and the second output voltage V₂ generated by the second circuit 230 as a function of frequency and incident angle under the fifth tuning configuration in which the inductors 216 (L₁) and 236 (L₂) each have an inductance of L₀, the capacitors 214 (C₁) and 234 (C₂) each have a capacitance of C₀, the coupling capacitor 202 (C_{C}) has a capacitance of 5*C₀, and the resistors 212 (R₁) and 232 (R₂) each have a resistance of 2*R₀. The axes represent frequency and incident angle, and a color scale represents a magnitude of the ratio V₁/V₂. Due to the increased damping introduced by the resistors 212 (R₁) and 232 (R₂) having resistances of 2*R₀, the resonance region appears broader relative to FIGS. 7A-7C, but the ratio V₁/V₂ continues to vary as a function of incident angle in the resonance band, demonstrating that directional sensitivity is preserved under increased damping conditions.

The embodiments described herein illustrate that a pair of capacitively coupled frequency selective circuits may be configured to produce respective electrical responses that vary predictably as a function of an incident angle of an acoustic wave. By comparing the resulting output voltages, directional information may be determined without requiring large mechanical structures or complex multi-element arrays. The electrical characteristics of the coupled circuits define a resonance behavior that is responsive to angular variations, enabling direction detection through analysis of relative voltage magnitude.

Further, one or more electrical parameters of the coupled circuits may be adjusted to tune resonance frequency, bandwidth, damping characteristics, and angular sensitivity while maintaining the underlying directional sensing principle. This tunability permits adaptation of the system to different operating frequencies, environmental conditions, or performance requirements. Accordingly, the disclosed architecture provides a scalable and electrically configurable approach to directional acoustic sensing suitable for integration into a wide range of sensing platforms.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures. The embodiments are not limited to the illustrated structure or application.

The systems, components and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the preceding. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the preceding. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the preceding. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the preceding specification, indicating the scope hereof.

What is claimed is:

1. A system comprising:
a first circuit and a second circuit capacitively coupled by a coupling capacitor, the first circuit and the second circuit each comprise an inductor, a capacitor, and a resistor forming a frequency-selective network;
a first acoustic transducer coupled to the first circuit and a second acoustic transducer coupled to the second circuit;
at least one electrical element of the first circuit, at least one electrical element of the second circuit, or the coupling capacitor is a tunable electrical element configured to alter at least one of a resonance frequency, a bandwidth, or a damping characteristic of the first circuit or the second circuit; and
wherein the first circuit and the second circuit generate respective output voltages that differ as a function of an incident angle of an acoustic wave.

2. The system of claim 1, further comprising a memory in communication with a processor and having instructions that, when executed by the processor, cause the processor to determine a direction of the acoustic wave based on the respective output voltages.

3. The system of claim 2, wherein the processor adjusts the tunable electrical element in response to a user input that specifies at least one of a target resonance frequency or a target operating frequency range.

4. The system of claim 2, wherein the processor automatically adjusts the tunable electrical element without user input based on at least one detected environmental condition comprising at least one of a sound frequency variation or an ambient temperature.

5. The system of claim 2, wherein the processor determines the direction based on a ratio of the respective output voltages.

6. The system of claim 1, wherein at least one of the inductor or the capacitor of at least one of the first circuit or the second circuit is tunable to shift a resonance frequency of the frequency-selective network.

7. The system of claim 1, wherein the coupling capacitor is tunable to adjust a bandwidth of an operating frequency range over which the respective output voltages differ as a function of the incident angle.

8. The system of claim 1, wherein at least one resistor of the first circuit or the second circuit is tunable to adjust a damping characteristic that modifies a contrast between the respective output voltages as a function of the incident angle.

9. The system of claim 1, wherein at least one electrical element of each of the first circuit and the second circuit is independently tunable.

10. The system of claim 1, wherein the coupling capacitor has a capacitance greater than a capacitance of the capacitor of the first circuit and a capacitance of the capacitor of the second circuit.

11. A method comprising:
receiving a first voltage from a first circuit connected to a first transducer and a second voltage from a second circuit connected to a second transducer, wherein the first circuit and the second circuit are capacitively coupled by a coupling capacitor;
tuning at least one electrical element of at least one of the first circuit, the second circuit, or the coupling capacitor to alter at least one of a resonance frequency, a bandwidth, or a damping characteristic of the first circuit or the second circuit; and
determining a direction of an acoustic wave detected by the first transducer and the second transducer based on the first voltage and the second voltage.

12. The method of claim 11, wherein the first circuit and the second circuit each comprise an inductor, a resistor, and a capacitor forming a frequency-selective network.

13. The method of claim 12, wherein at least one parameter of a resistor, a capacitor, and an inductor of the first circuit is substantially equal to at least one parameter of a resistor, a capacitor, and an inductor of the second circuit.

14. The method of claim 13, wherein the coupling capacitor has a capacitance greater than a capacitance of the capacitor of the first circuit and a capacitance of the capacitor of the second circuit.

15. The method of claim 11, wherein determining the direction comprises:
determining a ratio between the first voltage and the second voltage; and
based on the ratio and a mapping that maps the ratio to a mapped direction, determining the direction of the acoustic wave.

16. The method of claim 11, wherein tuning comprises mechanically adjusting at least one of an inductance of the first circuit, an inductance of the second circuit, a resistance of the first circuit, a resistance of the second circuit, or a capacitance of the coupling capacitor.

17. The method of claim 11, wherein tuning comprises electronically controlling at least one of an inductance, a resistance, or a capacitance of at least one of the first circuit, the second circuit, or the coupling capacitor using a processor.

18. A tunable capacitively coupled circuit comprising:
a first circuit comprising an inductor, a resistor, and a capacitor, the first circuit configured to be connected to a first transducer;
a second circuit comprising an inductor, a resistor, and a capacitor, the second circuit configured to be connected to a second transducer and capacitively coupled to the first circuit by a coupling capacitor; and
at least one tunable electrical element comprising at least one of the inductor, the resistor, or the capacitor of the first circuit, at least one of the inductor, the resistor, or the capacitor of the second circuit, or the coupling capacitor, wherein the at least one tunable electrical element is configurable to alter at least one of a resonance frequency, a bandwidth, or a damping characteristic of the first circuit or the second circuit.

19. The tunable capacitively coupled circuit of claim 18, wherein at least one parameter of a resistor, a capacitor, and an inductor of the first circuit is substantially equal to at least one parameter of a resistor, a capacitor, and an inductor of the second circuit.

20. The tunable capacitively coupled circuit of claim 18, wherein a capacitance of the coupling capacitor is greater than a capacitance of the capacitor of the first circuit and a capacitance of the capacitor of the second circuit.
